(19) United States
(12) Patent Application Publication
(10) Pub. No.: US 2010/0281623 A1
(43) Pub. Date: Nov. 11, 2010

(54) DECOLORIZATION OF FABRICS USING PHOSPHORIC AND PHOSPHOROUS ACID DERIVATIVES

(76) Inventors: Reed E. Oshel, Des Moines, IA (US); John G. Verkade, Ames, IA (US)

Correspondence Address: NIXON PEABODY LLP - PATENT GROUP, 1100 CLINTON SQUARE, ROCHESTER, NY, 14604, US

(21) Appl. No.: 12/738,578

(22) PCT Filed: Oct. 17, 2008
(86) PCT No.: PCT/US08/80276

§ 371 Date: Jul. 6, 2010

Related U.S. Application Data
(60) Provisional application No. 60/980,630, filed on Oct. 17, 2007.

(51) Int. Cl. C11D 3/395; D06L 3/02; C07F 9/09

(52) U.S. Cl. 8/102; 252/186.1; 558/74; 558/218

(57) ABSTRACT

The present invention is directed to a method of removing colorants from a material. The method includes providing colored material, providing an oxoacid or oxoacid ester of phosphorous acid, and combining the colored material and the oxoacid or oxoacid ester of phosphorous under conditions effective to remove the colorant from the colored material.

This application claims benefit of U.S. Provisional Patent Application Ser. No. 60/980,630, filed Oct. 17, 2007, which is hereby incorporated by reference in its entirety.

### FIELD OF THE INVENTION

This invention relates to decolorization of fabrics using phosphoric and phosphorous acid derivatives.

### BACKGROUND OF THE INVENTION

Efforts have been made to decolorize textile dyes with enzymes (see Ramsay, J., et al., Biotechnol. Lett., 24(21): 1757-1761 (2002); Ramsay, J., et al., Chemosphere, 61(7): 956-964 (2005)) to reclaim textiles, and, for environmental reasons, to decolorize dyes present in waste waters (see Teodorovic, S. et al., Magic World of Textiles, Book of Proc. of the Internat. Textile, Clothing & Design Conf, 1st, Dubrovnik, Croatia, Oct. 6-9, 725-729 (2002)) produced by the textile dyeing industry. Mueller, M., et al., Am. Assoc. of Textile Chemists and Colorists Rev., 1(7): 4-5 (2001) describes the use of an enzyme to decolorize a dye used in a colored fabric manufacturing process. Efforts are also being made by others to use enzymes present in fungi for fabric decoloration (see Teodorovic, S., et al., Magic World of Textiles, Book of Proc. of the Internat. Textile, Clothing & Design Conf, 1st, Dubrovnik, Croatia, Oct. 6-9, 725-729 (2002)). The use of white rot fungi in the decoloration of textile dyes is described in Swamy, J., et al., Enz. and Microb. Tech., 24(3/4): 130-137 (1999)). However, enzymic approaches are slow.

Chemical methods (which are typically faster than enzymes) for removing color from fabrics have long been known and are of the oxidative type (such as bleaching or ozonization) (see for example U.S. Pat. No. 743,013). Such chemical methods are by nature stoichiometric, often involve multiple chemicals, and also tend to oxidize the fabric to at least some extent.

The present invention is directed to overcoming these and other deficiencies in the art.

### SUMMARY OF THE INVENTION

One aspect of the present invention is directed to a method of removing colorants from a material. The method includes providing colored material, providing an oxoacid or oxoacid ester of phosphorous acid, and combining the colored material and the oxoacid or oxoacid ester of phosphorous acid under conditions effective to remove the colorant from the colored material.

The methods of the present invention are advantageous in that they: (a) are non-oxidative which therefore avoids stoichiometric consumption of the solvent and fabric oxidation, and facilitate recovery of the solvent for recycling; (b) require only one or two reagents which are inexpensive and commercially available; and (c) appear to completely decolorize highly colored polyester.

### BRIEF DESCRIPTION OF THE DRAWINGS

FIG. 1A-F is a photograph showing multi-colored polyester fabric before decoloration (FIG. 1A), after treatment with a mixture of water and P(OCH₂)₃CEt (FIG. 1B), after treatment with a mixture of water and P(OCH₂CH₃)₃ (FIG. 1C), and red polyester fabric before decoloration (FIG. 1D), after treatment with a mixture of water and P(OCH₂CH₃)₃ (FIG. 1E), and after treatment with a mixture of water and P(OCH₂)₃CEt (FIG. 1F).

### DETAILED DESCRIPTION OF THE INVENTION

One aspect of the present invention is directed to a method of removing colorants from a material. The method includes providing colored material, providing an oxoacid or oxoacid ester of phosphorous acid, and combining the colored material and the oxoacid or oxoacid ester of phosphorous acid under conditions effective to remove the colorant from the colored material.

A preferred embodiment includes adding water to the combined colored material and the oxoacid or oxoacid ester of phosphorous acid under conditions effective to remove the colorant from the colored material.

In certain embodiments, the colored material may be a polymer in the form of a fiber or a textile fiber. Suitable polymers include polyester.

The colorant can be a dye or pigment. Suitable dyes include acridine, anthraquinone, arylmethane, azo, cyanine, diazonium, nitro, nitroso, phthalocyannine, quinone, azin, indamins, indophenol, oxazin, oxazone, thiazin, thiazole, xanthene, fluorene and fluorone. Suitable pigments include alizarin, alizarin crimson, gamboge, indigo, indian yellow, cochineal red, tyrian purple, rose madder, pigment red 170, phthalo green, phthalo blue and quinacridone magenta, and inorganic pigments like cadmium sulfide.

Useful oxoacids of phosphorus include phosphorous acid, phosphoric acid, hypophosphorous acid, polyphosphoric acid, or mixtures thereof.

Suitable oxoacid esters of phosphorous acid are triesters of phosphorus, such as acyclic P(OR)₃, where each R is independently H or a substituted or unsubstituted C₁-C₆ alkyl group, a substituted or unsubstituted alkene group, or a substituted or unsubstituted alkyne group;

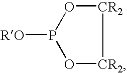

where R′ and each R is independently H or a substituted or unsubstituted C₁-C₆ alkyl group, a substituted or unsubstituted alkene group, or a substituted or unsubstituted alkyne group;

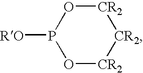

where R′ and each R is independently H or a substituted or unsubstituted C₁-C₆ alkyl group, a substituted or unsubstituted alkene group, or a substituted or unsubstituted alkyne group;

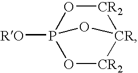

where R′ and each R is independently H or a substituted or unsubstituted C₁-C₆ alkyl group, a substituted or unsubstituted alkene group, or a substituted or unsubstituted alkyne group;

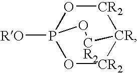

where R′ and each R is independently H or a substituted or unsubstituted C₁-C₆ alkyl group, a substituted or unsubstituted alkene group, or a substituted or unsubstituted alkyne group; and

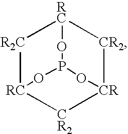

where each R is independently H or a substituted or unsubstituted C₁-C₆ alkyl group, a substituted or unsubstituted alkene group, or a substituted or unsubstituted alkyne group, and mixtures thereof.

The oxoacid or oxoacid ester of phosphorous acid is preferably in an aqueous solution.

In carrying out the method of the present invention, the colorant can be completely removed from the colored material or partially removed from the colored material. Depending on the qualities and quantities of material to be decolored, a skilled artisan can adjust the ratios of decolorant components, the ratios of decolorant to material, adjust the lengths of treatment times, and/or vary the number of repeated treatments (for example, repeating the treatment with a fresh solution of the same or different decolorant) to achieve partial or complete decoloration, as desired.

The conditions effective for removing the colorant from the colored material include a temperature of 100-200° C., preferably at a temperature of 125-175° C.

The method of the present invention may include removing the material from the solution after the combining step. The material can then be washed or rinsed. The washing or rinsing may be carried out by adding a solvent to the material. Suitable solvents include water or an alcohol, like C₁-C₆ alkanols, or mixtures thereof. Suitable solvents include acetone, acetonitrile, dimethylformamide, pyridine, tetrahydrofuran, or mixtures thereof.

It is well known that hydrolysis equilibria are reversible for many chemicals, phosphite esters are no exceptions (see Scheme 1 for an example). Thus, the process of the present invention can proceed from left to right in each equilibrium step, starting with, for example, P(OEt)₃ and water or, from right to left, starting from phosphorous acid and ethanol at the lower right of Scheme 1. For example, one can start with 3 equivalents of EtOH and an equivalent of phosphorous acid and, then, remove the water (e.g., with molecular sieves). This produces mainly P(OEt)₃.

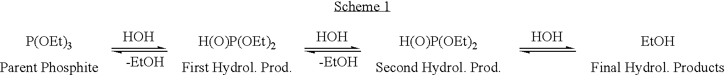

It is possible to start with phosphorous acid and the required alcohol to make a mixture of the first hydrolysis product and the second hydrolysis product or to start with the first hydrolysis product and, by adding the correct amount of water, make the same mixture as starting with phosphorous acid and the required alcohol.

It is generally possible to proceed in either direction of an equilibrium or sequence of equilibria. This process is governed by Le Chatelier's Principle.

It has been shown that the non-toxic first and second hydrolysis products of the toxic bicyclic phosphite P(OCH₂)₃CEt are the active species for effectively solubilizing a wide range of lignocellulosics and are expected to be effective agents for removing colorants from materials.

Synthesis of parent phosphite esters for subsequent hydrolysis (to make the desired ratio of first to second hydrolysis products) requires expense, time, and energy. This can be avoided by starting with phosphorous acid and the desired alcohol, diol, triol, or tetraol, followed by removing the appropriate amount of water. The mixture of decolorizing agents is created by proceeding from the final hydrolysis products and working toward parent phosphites but not actually synthesizing them.

Oxidative bleaching is the current industrial process for decolorization. However, that process is quite expensive and also causes undesirable oxidative destruction of the polyester. Oxidative bleaching could be used in combination with the present methods by employing minimal oxidative bleaching agent after the present methods accomplish complete to virtually complete decolorization.

One skilled in the art would recognize that substitution of a sulfur for one or more oxygens in a phosphorous oxoacid, oxoacid ester, a phosphoric oxoacid, or phosphoric acid ester would be possible as thiophosphorous and thiophosphoric compounds are well known. Such sulfur containing compounds, however, would be more expensive and pose environmental problems.

### EXAMPLES

### Example 1

### Decoloration of Multi-Colored Polyester Fabric with P(OCH₂)₃CEt

All reactions were carried out in a 20 mL pressure tube with vigorous stirring using a magnetic stir bar. After reactions were complete, the fabrics were removed and washed with methanol to remove any phosphite/water/dye solution. The results of four preliminary experiments are as follows.

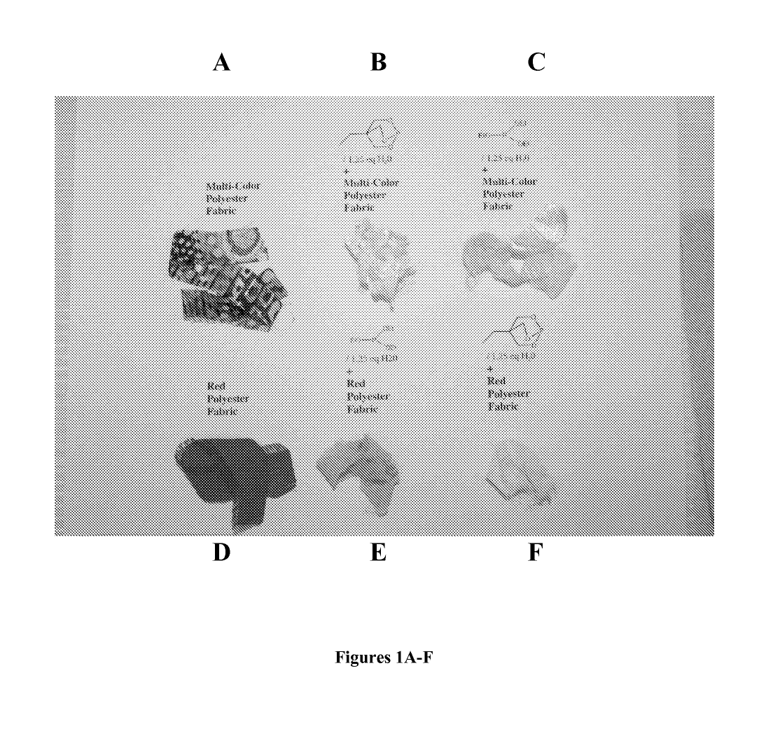

0.250 g multi-colored polyester fabric and 7.14 g of P(OCH₂)₃CEt and 1.25 eq H₂O heated at 150° C. for 24 hrs gave almost complete removal of color. Only 1.2% loss in mass of fabric was observed which could be attributed to dye removal. See FIGS. 1A and 1B.

### Example 2

### Decoloration of Red Colored Polyester Fabric with P(OCH₂)₃CEt

0.250 g red-colored polyester fabric and 7.14 g of P(OCH₂)₃CEt and 1.25 eq H₂O heated at 150° C. for 24 hrs gave almost complete removal of color. See FIGS. 1D and 1F.

### Example 3

### Decoloration of Red Colored Polyester Fabric with P(OCH₂CH₃)₃

0.250 g red-colored polyester fabric and 7.68 mL of P(OCH₂CH₃)₃ and 1.25 eq H₂O heated at 150° C. for 24 hrs gave almost complete removal of color. Only a slight pinkish tint remained. See FIGS. 1D and 1E.

### Example 4

### Decoloration of Multi-Colored Polyester Fabric with P(OCH₂CH₃)₃

0.250 g multi-colored polyester fabric and 7.68 mL of P(OCH₂CH₃)₃ and 1.25 eq H₂O heated at 150° C. for 24 hrs gave almost complete removal of color. Only a slight greenish color remained. See FIGS. 1A and 1C.

### Example 5

### Decoloration of Red Colored Polyester Fabric with Preheated Cage Phosphite

A 249.4 mg sample of the red fabric was added to 7.1 g of cage phosphite at room temperature, then the mixture was placed in an oil bath preheated to 150° C., and the mixture heated at 150° C. for 24 h. During the first 2 h, it was noted that the cloth sample became white while the solution became yellow. These observations persisted over the 24 h period. At the end of this period, the cloth sample was withdrawn and washed copiously with methanol from a wash bottle, after which it was dried in air and weighed. The weight loss (due presumably mainly to dye loss) was 2.2 mg.

### Example 6

### Decoloration of Red Colored Polyester Fabric with Room Temperature Cage Phosphite

A 252.2 mg sample of the red fabric was added to 7.1 g of cage phosphite at room temperature. The mixture was brought to 150° C. and held there for 24 h. The observations and subsequent procedures were the same as in Example 5 except that the weight loss (due presumably mainly to dye loss) was 1.90 mg.

### Example 7

### Decoloration of Red Colored Polyester Fabric with Preheated Cage Phosphite and Water

Example 5 was repeated with: A 252.2 mg sample of the red fabric mixed with 7.1 g of cage phosphite and 1.25 equivalents of water (1.0 mL) at room temperature, then the mixture was placed in an oil bath preheated to 150° C., and the mixture kept at 150° C. for 27 h. Decolorization was slower than in Example 5, but it did become complete at some time during the 27 h and the solution became yellow. After washing and drying the cloth as in Example 5, the weight loss (due presumably mainly to dye loss) was 1.30 mg.

### Example 8

### Decoloration of Red Colored Polyester Fabric with Room Temperature Cage Phosphite and Water

Example 7 was repeated with: A 255.6 mg sample of the red fabric mixed with 7.1 g of cage phosphite and 1.25 equivalents of water (1.0 mL) at room temperature. The mixture was brought to 150° C. and held there for 43 h. Decolorization was slower than in Example 7, and it was not complete over this period, although the solution became pale yellow. The cloth was washed and dried as in Example 5, but the weight loss (due presumably mainly to dye loss) was 2.0 mg. The cloth had become a very pale pink with regions that appeared to be virtually white.

### Example 9

### Decoloration of Blue Colored Polyester Fabric with Preheated Cage Phosphite

A 257.4 mg sample of the blue fabric was added to 7.1 g of cage phosphite at room temperature, then the mixture was placed in an oil bath preheated to 150° C., and held at that temperature for 43 h. After 2 h, the cloth sample appeared to become white in the hot blue solution. This was also the case over the 43 h period. At the end of this period, the cloth sample was withdrawn and washed and dried as in Example 5, and the cloth sample appeared as pale blue. The cloth was not weighed, but subjected to the conditions of Example 11 below.

Following the performance of the above experiments, it appeared likely that cheaper and non-toxic triethyl phosphite [P(OCH₂CH₃)₃] or triethyl phosphite+water, for example, are effective in decolorizing polyesters.

### Example 10

### Decoloration of Red Colored Polyester Fabric with Preheated Triethyl Phosphite

A 245.0 mg sample of the red fabric was added to 7.5 mL of triethyl phosphite. The mixture was placed in an oil bath which was preheated to 150° C. and the mixture held at that temperature for 11 h. After 2 h the cloth sample became white while the solution became pale yellow. This was also the case over the 11 h period. At the end of this period, the cloth sample was withdrawn and washed, dried, and weighed as in Example 5 except that washing was done with copious amounts of ethanol from a wash bottle. The weight loss (due presumably mainly to dye loss) was 1.7 mg.

### Example 11

### Decoloration of Blue Colored Polyester Fabric with Preheated Cage Phosphite and Further Decoloration with Preheated Triethyl Phosphite

The pale blue cloth sample from Example 9 was added to 7.5 mL of triethyl phosphite. The mixture was placed in an oil bath which was preheated to 150° C. and the mixture held at that temperature for 66 h. The cloth looked white in the hot blue liquid after 2 h, and this was also the case over the 66 h period. At the end of this period, the cloth sample was withdrawn and washed, dried, and weighed as in Example 5 except that washing was done with copious amounts of ethanol from a wash bottle. The cloth sample had become almost white, but it still retained a slightly bluish tinge. The weight loss (due presumably mainly to dye loss) was 1.3 mg.

### Example 12

### Decoloration of Blue Colored Polyester Fabric with Preheated Triethyl Phosphite

A 266.5 mg sample of the blue fabric was added to 7.5 mL of triethyl phosphite. The mixture was placed in an oil bath which was preheated to 150° C. and the mixture held at that temperature for 27 h. The cloth looked white in the hot blue liquid after 2 h, and this was also the case over the 27 h period. At the end of this period, the cloth sample was withdrawn and washed and dried as in Example 5 except that washing was done with copious amounts of ethanol from a wash bottle. The weight loss (due presumably mainly to dye loss) was 1.8 mg. The cloth was a very pale blue.

### Example 13

### Decoloration of Blue Colored Polyester Fabric with Preheated Triethyl Phosphite and Water

A 268.9 mg sample of the blue fabric was added to a mixture of 7.5 mL of triethyl phosphite and 0.33 equivalent (0.26 mL) of water. The mixture was placed in an oil bath which was preheated to 150° C. and the mixture held at that temperature for 24 h. The cloth looked white in the hot blue liquid after 2 h, and this was also the case over the 24 h period. At the end of this period, the cloth sample was withdrawn and washed with copious amounts of ethanol from a wash bottle and dried. The cloth which was pale blue was not weighed but was used directly in Example 14 below.

### Example 14

### Repeated Decoloration of Decolored Blue Colored Polyester Fabric with Preheated Triethyl Phosphite and Water

The cloth from Example 13 was subjected to a repeat treatment with the aforementioned triethyl phosphite/water mixture at the same temperature for the same length of time. At the end of the treatment period, the cloth sample was withdrawn and washed with copious amounts of ethanol from a wash bottle and dried. The cloth was now mostly white with a few patches of very pale blue. The weight loss (due to dye loss and also substantial cloth hydrolysis/dissolution) was 16.4 mg.

### Example 15

### Decoloration of Blue Colored Polyester Fabric with Preheated Triethyl Phosphite and Excess Water

A 244.2 mg sample of the blue fabric was added to a mixture of 7.5 mL of triethyl phosphite and 1.25 equivalent (1.0 mL) of water. The mixture was placed in an oil bath which was preheated to 150° C. and the mixture held at that temperature for 48 h. At the end of this period, the cloth sample had become a white powder which was washed with copious amounts of ethanol from a wash bottle, dried, and weighed as in Example 5. The weight of the powder was only 66.0 mg due to dye loss and also very substantial cloth hydrolysis/dissolution.

### Example 16

### Decoloration of Blue Colored Polyester Fabric with Preheated H(O)P(OCH₂CH₃)₂

A 246.0 mg sample of the blue fabric was added to 5.6 mL of H(O)P(OCH₂CH₃)₂ (which is the first hydrolysis product of triethyl phosphite). The mixture was placed in an oil bath which was preheated to 150° C. and the mixture held at that temperature for 24 h. The cloth looked white in the hot blue liquid after 2 h and this was also the case over the 24 h period. At the end of this period, the cloth sample was withdrawn and washed with copious amounts of ethanol from a wash bottle, dried, and weighed as in Example 5. The cloth was pale blue as in Example 15. The weight loss (due presumably mainly to dye loss) was 1.7 mg.

### Example 17

### Repeated Decoloration of Decolored Blue Colored Polyester Fabric with Preheated H(O)P(OCH₂CH₃)₂

The cloth from Example 16 was subjected to a repeat treatment with H(O)P(OCH₂CH₃)₂ at the same temperature for the same length of time. At the end of the treatment period, the cloth sample was withdrawn and washed with copious amounts of ethanol from a wash bottle and dried. The cloth was now mostly white with a few patches of very pale blue. The total weight loss (due to dye loss and some cloth due to derivatization/hydrolysis/dissolution) was 4.3 mg.

### Example 18

### Decoloration of Blue Colored Polyester Fabric with Preheated Phosphorous Acid

A 253.8 mg sample of the blue fabric was added to 3.6 g of 99% pure commercially available phosphorous acid {H(O)P(OH)₂ (i.e., not an aqueous solution) which is the final hydrolysis product of any phosphite ester}. The mixture was placed in an oil bath which was preheated to 150° C. and the mixture held at that temperature for 36 h. The cloth looked white in the hot blue liquid after 12 h and some grayish white powder was also present. At the end of the 36 h period, the cloth sample had turned to a grayish white powder which was washed with copious amounts of ethanol from a wash bottle. However, it was not possible to measure a weight loss owing to loss of most of the powder through the filter paper into the filtrate due to the small size of the particles.

### Example 19

### Decoloration of Black Colored Polyester Fabric with Preheated Triethyl Phosphite

A 249.4 mg sample of the black fabric was added to 7.5 mL of triethyl phosphite. The mixture was placed in an oil bath which was preheated to 150° C. and the mixture held at that temperature for 27 h. The cloth appeared orange in the hot red liquid after 1 h. At the end of the 27 h, the orange cloth sample was withdrawn and washed with copious amounts of ethanol from a wash bottle and dried as in Example 5. The cloth was not weighed because it was directly used for Example 20.

### Example 20

### Further Decoloration of Decolored Black Colored Polyester Fabric with Preheated Triethyl Phosphite and Excess Water

The cloth sample from Example 19 was added to a mixture of 7.5 mL of triethyl phosphite plus 1.25 equivalents (1.0 mL) of water. The mixture was placed in an oil bath which was preheated to 150° C. and the mixture held at that temperature for 12 h. At the end of the 12 h, the orange cloth sample had become a white powder which was washed with copious amounts of ethanol from a wash bottle, dried as in Example 5, and weighed. The weight loss from the powder (due presumably mainly to dye loss and substantial cloth dissolution) was 34.4 mg.

### Example 21

### Decoloration of Black Colored Polyester Fabric with Preheated Triethyl Phosphite and Water

A 220.8 mg sample of the black fabric was added to 7.5 mL of a mixture of triethyl phosphite and 0.33 equivalent (0.26 mL) of water. The mixture was placed in an oil bath which was preheated to 150° C. and the mixture held at that temperature for 72 h. After 2 h, most of the color was lost, and this was also the case over the remaining reaction time. At the end of the 72 h, the pale orange cloth sample was withdrawn and washed with copious amounts of ethanol from a wash bottle, dried, and weighed as in Example 5. The weight loss (due presumably mainly to dye loss) was 3.0 mg.

### Example 22

### Decoloration of Multi-Colored Polyester Fabric with Preheated Triethyl Phosphite

A 254.1 mg sample of a multi-colored fabric (a combination of yellow, blue, ochre, brown, khaki, red, and black patterns) was added to 7.5 mL of triethyl phosphite. The mixture was placed in an oil bath which was preheated to 150° C. and the mixture held at that temperature for 48 h. The liquid was red. At the end of this period, the cloth sample was withdrawn and washed with copious amounts of ethanol from a wash bottle and dried. The cloth was almost completely decolorized; retaining regions of white, very pale pink and very pale yellow or very pale orange. The loss in weight (due presumably mainly to dye loss) was 2.4 mg.

### Example 23

### Decoloration of Glossy Finished Multi-Colored Polyester Fabric with Preheated Triethyl Phosphite

A 253.7 mg sample of a glossy finished multi-colored fabric (a combination of white, gray, and black) was added to 7.5 mL of triethyl phosphite. The mixture was placed in an oil bath which was preheated to 150° C. and the mixture held at that temperature for 48 h. The liquid phase was red. At the end of the reaction period, the cloth sample was withdrawn and washed with copious amounts of ethanol from a wash bottle and dried. It appeared that the gray patterns disappeared, and a light orange color remained in the formerly black patterns. Also, the glossy surface of the fabric had disappeared. The loss in weight (due presumably mainly to dye loss and glossy finish) was 3.7 mg.

### Example 24

### Decoloration of Open Weave Multi-Colored Polyester Fabric with Preheated Triethyl Phosphite

A multi-colored open weave fabric (a combination of yellow, blue, orange, red, and black) was employed. Because of sample-size considerations for the small glass tube reactor, a sample (252.0 mg) consisting of only a black, orange, and yellow color was used. This sample was added to 7.5 mL of triethyl phosphite. The mixture was placed in an oil bath which was preheated to 150° C. and the mixture held at that temperature for 48 h. The liquid was red. At the end of this period, the cloth sample was withdrawn and washed with copious amounts of ethanol from a wash bottle and dried. The loss in weight (due presumably mainly to dye loss and probably some fabric loss) was 6.9 mg. All the colors in the sample disappeared except an orange color where the black patterns were, and a pale yellow to off white coloration where the orange and yellow patterns had been.

### Example 25

### Repeated Decoloration of Various Multi-Colored Polyester Fabric with Preheated Triethyl Phosphite and Water

Samples of approximately equal size of a multi-colored fabric (a combination of yellow, blue, ochre, brown, khaki, red, and black patterns), a red fabric, a blue fabric, and a black fabric weighing a total of 908.0 g were added to a mixture of 19.0 mL of triethyl phosphite and 1.0 equivalent (2.0 mL) of water. The mixture was placed in an oil bath which was preheated to 150° C. and the mixture held at that temperature for 24 h. At the end of this period, the cloth samples were withdrawn from the deep green liquid and washed with copious amounts of ethanol from a wash bottle and dried. The cloth was grass-green in color. Treatment of these samples was repeated with a fresh batch of the same triethyl phosphite/water mixture preheated to 150° C. After 5 minutes at 150° C., all the samples had become white, and the liquid had become pale green. After 5 h, some of the fabric had turned to a white powder and at the end of 24 h, all the samples had become a white powder and the liquid had become pale green. The powder was filtered off, washed with copious amounts of ethanol from a wash bottle, and dried. The final weight of the powder (599.0 mg) indicated that 309.0 mg of fabric was lost from the original weight.

### Example 26

### Three Consecutive Decoloration Treatments of Various Polyester Fabrics with Preheated Triethyl Phosphite and Water

Samples of approximately equal size of a multi-colored fabric (a combination of yellow, blue, ochre, brown, khaki, red, and black patterns), a second multi-colored fabric, namely, a glossy finished one (a combination of white, gray, and black patterns), and a third multi-colored fabric multi-colored, namely an open weave one (a combination of yellow, blue, turquoise, green, orange, red, pink, and black; although for sample size considerations the cloth piece consisted only of turquoise, green, blue, red, pink, and black) were used. Also included was a sample of a red fabric, a blue fabric, and a black fabric. The total weight of the 6 samples was 1.4349 g. All 6 samples were added to a mixture of 23.8 mL of triethyl phosphite and 1.0 equivalent (2.5 mL) of water. The mixture was placed in an oil bath which was preheated to 150° C. and the mixture held at that temperature for 2 h. At the end of 2 h, all the cloth samples appeared to be white and were withdrawn from the dark brown liquid, washed with copious amounts of ethanol from a wash bottle, and dried. Although the dried samples appeared to be efficiently decolorized, they retained a somewhat grayish appearance. The cloth samples had lost a total of 27.7 mg indicating that the mass loss (1.9%) was mainly due to loss of dyes and the glossy finish which on one of the samples now appeared to be gone.

Treatment of these samples was repeated with a fresh batch of the same triethyl phosphite/water mixture. The mixture was placed in an oil bath preheated to 150° C. and the mixture held at that temperature for 5 min. The liquid had taken on a grayish color and the cloth samples appeared to be white in the grayish liquid. The samples were withdrawn from the liquid, washed with copious amounts of ethanol from a wash bottle, and dried. All of the samples now appeared to be white with the exception of 2 samples, namely, the originally blue one and the originally black one which still had a very faint bluish tinge and the originally multicolored one (containing the yellow, blue, ochre, brown, khaki, red, and black patterns) which retained a few faintly pink patches. The total weight loss from this second treatment was only 2.8 mg (0.2%), indicating that the mass loss was probably mainly associated with fiber loss, since the dye loss would have been minimal due to the first treatment.

Treatment of these samples (which now had a total weight of 1.4044 g) was repeated once again with a fresh batch of the same triethyl phosphite/water mixture. The mixture was placed in an oil bath preheated to 150° C. and the mixture held at that temperature for 30 min. At the end of this period, the liquid was colorless and the cloth samples appeared to be white. The samples were withdrawn from the liquid, washed with copious amounts of ethanol from a wash bottle, and dried. All of the samples now appeared to be white with the exception of only 2 samples, namely, the originally blue one which was now even more faintly blue than from the second treatment, and the originally multicolored one (containing the yellow, blue, ochre, brown, khaki, red, and black patterns) which retained a few patches which were now even more faintly pink than after the second treatment. The total weight loss from this third treatment was 6.9 mg (0.5%), indicating that the mass loss was probably mainly associated with fiber loss.

Although preferred embodiments have been depicted and described in detail herein, it will be apparent to those skilled in the relevant art that various modifications, additions, substitutions, and the like can be made without departing from the spirit of the invention and these are therefore considered to be within the scope of the invention as defined in the claims which follow.

What is claimed:

1. A method of removing colorants from a material comprising:
providing colored material;
providing an oxoacid or oxoacid ester of phosphorous acid; and
combining the colored material and the oxoacid or oxoacid ester of phosphorous acid under conditions effective to remove the colorant from the colored material.

2. The method of claim 1 further comprising:
adding water to the combined colored material and the oxoacid or oxoacid ester of phosphorous acid under conditions effective to remove the colorant from the colored material.

3. The method of claim 1, wherein the colored material is a polymer.

4. The method of claim 3, wherein the polymer is a fiber.

5. The method of claim 4, therein the fiber is a textile fiber.

6. The method of claim 3, wherein the polymer is polyester.

7. The method of claim 1, wherein the oxoacid or oxoacid ester of phosphorous acid is in an aqueous solution.

8. The method of claim 1, wherein an oxoacid of phosphorous acid is provided.

9. The method of claim 8, wherein the oxoacid of phosphorous acid is selected from the group consisting of phosphorous acid, phosphoric acid, hypophosphorous acid, polyphosphoric acid, and mixtures thereof.

10. The method of claim 1, wherein an oxoacid ester of phosphorus acid is provided.

11. The method of claim 10, wherein the oxoacid ester of phosphorus acid is a triester of phosphorous acid.

12. The method of claim 11, wherein the triester of phosphorous acid is selected from the group consisting of acyclic P(OR)₃, where each R is independently H or a substituted or unsubstituted C₁-C₆ alkyl group, a substituted or unsubstituted alkene group, or a substituted or unsubstituted alkyne group; 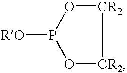
where R′ and each R is independently H or a substituted or unsubstituted C₁-C₆ alkyl group, a substituted or unsubstituted alkene group, or a substituted or unsubstituted alkyne group; 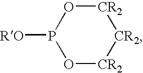
where R′ and each R is independently H or a substituted or unsubstituted C₁-C₆ alkyl group, a substituted or unsubstituted alkene group, or a substituted or unsubstituted alkyne group; 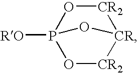
where R′ and each R is independently H or a substituted or unsubstituted C₁-C₆ alkyl group, a substituted or unsubstituted alkene group, or a substituted or unsubstituted alkyne group; 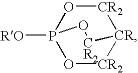
where R′ and each R is independently H or a substituted or unsubstituted C₁-C₆ alkyl group, a substituted or unsubstituted alkene group, or a substituted or unsubstituted alkyne group; and 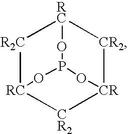
where each R is independently H or a substituted or unsubstituted C₁-C₆ alkyl group, a substituted or unsubstituted alkene group, or a substituted or unsubstituted alkyne group, and mixtures thereof.

13. The method of claim 1, wherein the colorant is completely removed from the colored material.

14. The method of claim 1, wherein the colorant is partially removed from the colored material.

15. The method of claim 1, wherein said combining is carried out at a temperature of 100-200° C.

16. The method of claim 15, wherein said combining is carried out at a temperature of 125-175° C.

17. The method of claim 1 further comprising:
removing the material from the solution after said combining and
washing or rinsing the material.

18. The method of claim 17, wherein said washing or rinsing comprises:
adding a solvent to the material.

19. The method of claim 18, wherein said solvent is water or an alcohol.

20. The method of claim 19, wherein said solvent is a C₁-C₆ alkanol.

21. The method of claim 18, wherein said solvent comprises at least one organic solvent.

22. The method of claim 1, wherein said colorant is a dye.
